(19) United States
(12) Patent Application Publication
(10) Pub. No.: US 2016/0063546 A1
(43) Pub. Date: Mar. 3, 2016

(54) METHOD AND SYSTEM FOR MAKING TIMELY AND TARGETED OFFERS

(71) Applicant: MASTERCARD INTERNATIONAL INCORPORATED, Purchase, NY (US)

(72) Inventors: Debashis Ghosh, Charlotte (NC); Randall K. Shuken, Westport, CT (US); Sebastian Shuken, Westport, CT (US)

(21) Appl. No.: 14/471,135

(22) Filed: Aug. 28, 2014

(51) Int. Cl. G06Q 30/02

(52) U.S. Cl. CPC G06Q 30/0255

(57) ABSTRACT

A method for making a timely and targeted offer by an entity to an audience of potential acceptors is provided. The method involves retrieving information including purchasing and payment activity information attributable to the audience having a transaction, date and time identifier; retrieving information including website browsing information attributable to the audience having a website, date and time identifier for one or more websites visited by the audience; correlating the information to generate one or more predictive behavioral models; identifying time and date patterns associated with activities and characteristics attributable to the audience; and conveying to the entity the time and date patterns associated with the activities and characteristics attributable to the audience, to enable the entity to make a timely and targeted offer to the audience. A system for making a timely and targeted offer by an entity to an audience of potential acceptors is also provided.

### BACKGROUND OF THE DISCLOSURE

1. Field of the Disclosure

The present disclosure relates to a method and a system for making timely and targeted offers to an audience of potential acceptors. More particularly, the present disclosure relates to a method and a system for making timely and targeted offers to an audience of potential acceptors using purchasing and payment activity information and website browsing information.

2. Description of the Related Art

Marketing expenses are often one of the largest cost categories for an organization. Marketing difficulties in effectively capturing and reaching the correct population of consumers is an industry wide problem, regardless of goods or services offered. In an attempt to overcome these difficulties, entities often engage in various advertising techniques to a broad audience hoping to reach interested consumers. However, such broad advertising techniques are often ignored by consumers or fail to reach the intended audience.

Information on consumers or potential purchasers can be very important to sellers of goods and services. Advertisers benefit from having detailed information about buying interests or capacities of potential purchasers of goods or services. If an advertiser, for instance, can identify and selectively advertise to those potential purchasers who fit a profile of probable consumers or purchasers of the advertiser's goods or services, the advertiser can reduce advertising costs by advertising directly to those potential purchasers. In other words, if the advertiser has both information about potential purchasers and more targeted access for its messages, it can achieve more purchasers/customers for the same amount of money. Useful financial and demographic information for such a strategy includes a potential purchaser's financial status, age, residence, and interests in various goods and services.

If an advertiser has access to such financial and demographic information about a potential purchaser, the advertiser can potentially selectively market to the more promising purchasers for a decreased expense per sales transaction. The money saved by the advertiser can, potentially, be used to reduce the price of the good or service to the purchaser. Instead of advertising to the masses of potential purchasers, the advertiser can concentrate on specific potential purchasers who will be likely to buy a specific good or service and offer favorable pricing.

Using relevant data, consumer activities and characteristics typically provide an effective form of targeted marketing by creating a shopping experience that is personalized and relevant to the consumer. However, targeted marketing systems are often limited to accessing only a specific set of data that provides less than a holistic view of a consumer's spending habits and preferences, including time and date patterns associated with the consumer's spending habits and preferences.

Businesses and merchants are constantly seeking ways to operate in a sales environment where they are able to deliver advertising messages and offers to their target audience at the opportune time. For many, the best time for reaching potential purchasers or consumers is at a time when the consumer is online shopping at a website. At other times, the most ideal scenario for a consumer to receive their advertisements and offers is when they are physically in the sales area or approaching the sales area. In such instances, there is a need to provide advertising messages and offers to potential consumers just-in-time, and at the right place, to enhance the sale of goods and services to those potential consumers.

Therefore, a need exists for a system that can provide a more effective form of targeted marketing by creating a shopping experience that is more personalized and relevant to the consumer, and that is delivered to the consumer at an opportune time. A more holistic view of a consumer's personal circumstances, including spending habits, preferences and time and date of spending, is needed for effective targeted marketing. Further, a need exists for a system that can analyze a customer's personal circumstances and identify customer activities and circumstances that can represent an opportunity for a merchant to offer products or services to the consumer at a particular date and time, that are specifically tailored to the consumer's upcoming need or desire and communicate the offers to the consumer.

### SUMMARY OF THE DISCLOSURE

The present disclosure provides a method and a system for making a timely and targeted offer by an entity to an audience of potential acceptors, specifically for the entity associating or otherwise partnering with a financial transaction processing entity to identify ideal consumers for marketing purposes through the generation of predictive behavioral models that are based upon purchasing and payment activity information and website browsing information attributable to the audience of potential acceptors.

The present disclosure further provides such a system and method that also enables the entity to make a timely and targeted offer to the audience of potential acceptors.

The present disclosure also provides a method for making a timely and targeted offer by an entity to an audience of potential acceptors. The method includes: retrieving, from one or more databases, a first set of information including purchasing and payment activity information attributable to the audience of potential acceptors (at least a portion of the purchasing and payment activity information has a transaction, date and time identifier); retrieving, from one or more databases, a second set of information including website browsing information attributable to the audience of potential acceptors (at least a portion of the website browsing information has a website, date and time identifier for one or more websites visited by the audience of potential acceptors); correlating the first set of information with the second set of information to generate one or more predictive behavioral models; identifying activities and characteristics, including time and date patterns associated with the activities and characteristics, attributable to the audience of potential acceptors based on the one or more predictive behavioral models; and conveying to the entity the activities and characteristics that include the time and date patterns associated with the activities and characteristics, attributable to the audience of potential acceptors based on the one or more predictive behavioral models, to enable the entity to make a timely and targeted offer to the audience of potential acceptors.

The present disclosure further provides a system for making a timely and targeted offer by an entity to an audience of potential acceptors. The system includes: one or more databases configured to store a first set of information including purchasing and payment activity information attributable to the audience of potential acceptors (at least a portion of the purchasing and payment activity information has a transaction, date and time identifier); and one or more databases configured to store a second set of information including website browsing information attributable to the audience of potential acceptors (at least a portion of the website browsing information has a website, date and time identifier for one or more websites visited by the audience of potential acceptors). The system also includes a processor configured to: correlate the first set of information with the second set of information to generate one or more predictive behavioral models; and identify activities and characteristics, including time and date patterns associated with the activities and characteristics, attributable to the audience of potential acceptors based on the one or more predictive behavioral models. The system further includes a device for conveying to the entity the activities and characteristics, including the time and date patterns associated with the activities and characteristics, attributable to the audience of potential acceptors based on the one or more predictive behavioral models, to enable the entity to make a timely and targeted offer to the audience of potential acceptors.

The present disclosure still further provides a method for generating one or more predictive behavioral models. The method involves retrieving, from one or more databases, a first set of information including purchasing and payment activity information attributable to the audience of potential acceptors (at least a portion of the purchasing and payment activity information has a transaction, date and time identifier); retrieving, from one or more databases, a second set of information including website browsing information attributable to the audience of potential acceptors (at least a portion of the website browsing information has a website, date and time identifier for one or more websites visited by the audience of potential acceptors); analyzing the first set of information and the second set of information to determine behavioral information of the audience of potential acceptors; extracting information related to an intent of the audience of potential acceptors from the behavioral information; and generating one or more predictive behavioral models based on the behavioral information and intent of the audience of potential acceptors. The audience of potential acceptors will have a propensity to carry out certain activities based on the one or more predictive behavioral models.

These and other systems, methods, objects, features, and advantages of the present disclosure will be apparent to those skilled in the art from the following detailed description of the embodiments and the drawings.

### BRIEF DESCRIPTION OF THE DRAWINGS

FIG. 1 is a block diagram illustrating a high-level view of system architecture of a financial transaction processing system in accordance with exemplary embodiments of the present disclosure.

FIG. 2 illustrates a data warehouse shown in FIG. 1 that is a central repository of data that is created by storing certain transaction data from transactions occurring within four party payment card system of FIG. 1.

FIG. 3 shows illustrative information types used in the systems and the methods of the present disclosure.

FIG. 4 illustrates an exemplary dataset for the storing, reviewing, and/or analyzing of information used in the systems and the methods of the present disclosure.

FIG. 5 is a flow chart illustrating a method for generating predictive behavioral models in accordance with exemplary embodiments of the present disclosure.

FIG. 6 is a block diagram illustrating a method for making a timely and targeted offer by a merchant to an audience of potential acceptors in accordance with exemplary embodiments of the present disclosure.

A component or a feature that is common to more than one figure is indicated with the same reference number in each figure.

### DESCRIPTION OF THE EMBODIMENTS

Embodiments of the present disclosure can now be described more fully hereinafter with reference to the accompanying drawings, in which some, but not all, embodiments of this disclosure are shown. Indeed, the present disclosure can be embodied in many different forms and should not be construed as limited to the embodiments set forth herein; rather, these embodiments are provided so that this disclosure satisfies applicable legal requirements. Like numbers refer to like elements throughout.

As used herein, entities can include one or more persons, organizations, businesses, institutions and/or other entities, including but not limited to, financial institutions and services providers, that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It can be understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of this disclosure.

Thus, apparatus, systems, methods and computer program products are herein disclosed to generate predictive behavioral models, to identify, analyze, extract and correlate consumer activities and characteristics, including time and date patterns associated with the activities and characteristics, that represent an opportunity to target offer products or services to the consumer and for timely communicating the target offers to the consumer, and also an opportunity for predicting consumer behavior and intent. Embodiments of the present disclosure will leverage the information available to identify data that is indicative of a customer's activities and characteristics, including time and date patterns associated with the activities and characteristics, and to predict consumer behavior and intent based on those activities and characteristics. Such activities and characteristics can include, but are not limited to, spending behavior, website browsing behavior, age, gender, geography, and the like. By identifying and analyzing consumer activities and characteristics, including time and date patterns associated with the activities and characteristics, based on predictive behavioral models, one can timely offer products and services that are relevant to the consumer's needs.

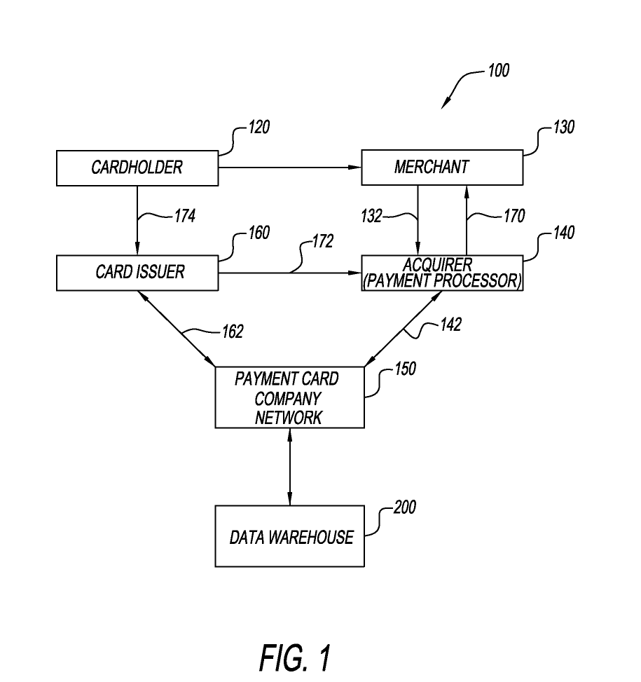

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes the financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

Data warehouse 200 is a database used by payment card company network 150 for reporting and data analysis. According to one embodiment, data warehouse 200 is a central repository of data that is created by storing certain transaction data from transactions occurring within four party payment card system 100. According to another embodiment, data warehouse 200 stores, for example, the date, time, amount, location, merchant code, and merchant category for every transaction occurring within payment card network 150.

In yet another embodiment, data warehouse 200 stores, reviews, and/or analyzes information used in: (i) constructing one or more definitions of payment card transaction date and time and one or more payment card holder lists by payment card transaction date and time period to identify payment card holder overlap, (ii) constructing one or more definitions of payment card transaction date and time, one or more definitions of web browsing pattern, date and time, and one or more payment card holder lists by payment card transaction date and time period and by web browsing pattern, date and time to identify payment card holder overlap, (iii) creating one or more groupings of payment card, transaction date and time periods and web browsing pattern, date and time based on the payment card holder overlap, and (iv) creating one or more datasets to store information relating to the one or more groupings of payment card transaction date and time periods and web browsing pattern, date and time periods.

In still another embodiment, data warehouse 200 stores, reviews, and/or analyzes information used in creating one or more datasets to store information relating to the one or more groupings of payment card transaction date and time periods and web browsing pattern, date and time periods.

In another embodiment, data warehouse 200 stores, reviews, and/or analyzes information used in developing logic for creating one or more groupings payment card transaction date and time periods and web browsing pattern, date and time periods based on the payment card holder overlap, and information used in applying the logic to a universe of payment card transaction date and time periods and web browsing pattern, date and time periods to create associations between the payment card transaction date and time periods and the web browsing pattern, date and time periods.

In still another embodiment, data warehouse 200 stores, reviews, and/or analyzes information used in quantifying the strength of the one or more associations between the one or more payment card holders and the one or more groupings of payment card transaction date and time periods and web browsing pattern, date and time periods.

In another embodiment, data warehouse 200 stores, reviews, and/or analyzes information, with respect to the one or more associations amongst the one or more payment card holders, the one or more groupings of payment card transaction date and time periods and the web browsing pattern, date and time periods, used in assigning attributes to the one or more payment card holders, the one or more groupings of payment card transaction date and time periods and web browsing pattern, date and time periods. The attributes are selected from the group consisting of one or more of confidence, time, and frequency.

In yet another embodiment, data warehouse 200 stores, reviews, and/or analyzes information used in identifying one or more payment card holders, one or more groupings of payment card transaction date and time periods, and web browsing pattern, date and time periods, and strength of the one or more associations between the one or more payment card holders and the one or more groupings of payment card transaction date and time periods, and web browsing pattern, date and time periods.

In still another embodiment, data warehouse 200 stores, reviews, and/or analyzes information used in targeting information including at least one or more suggestions or recommendations for payment card holder spending or purchasing activity at a geolocation, based on the one or more associations amongst the one or more payment card holders, the one or more groupings of payment card transaction date and time periods, and web browsing pattern, date and time periods.

In another embodiment, data warehouse 200 aggregates the information by merchant and/or category and/or location. In still another embodiment, data warehouse 200 integrates data from one or more disparate sources. Data warehouse 200 stores current, as well as historical, data and information that is used for creating reports, performing analyses on the network, merchant analyses, and performing predictive analyses.

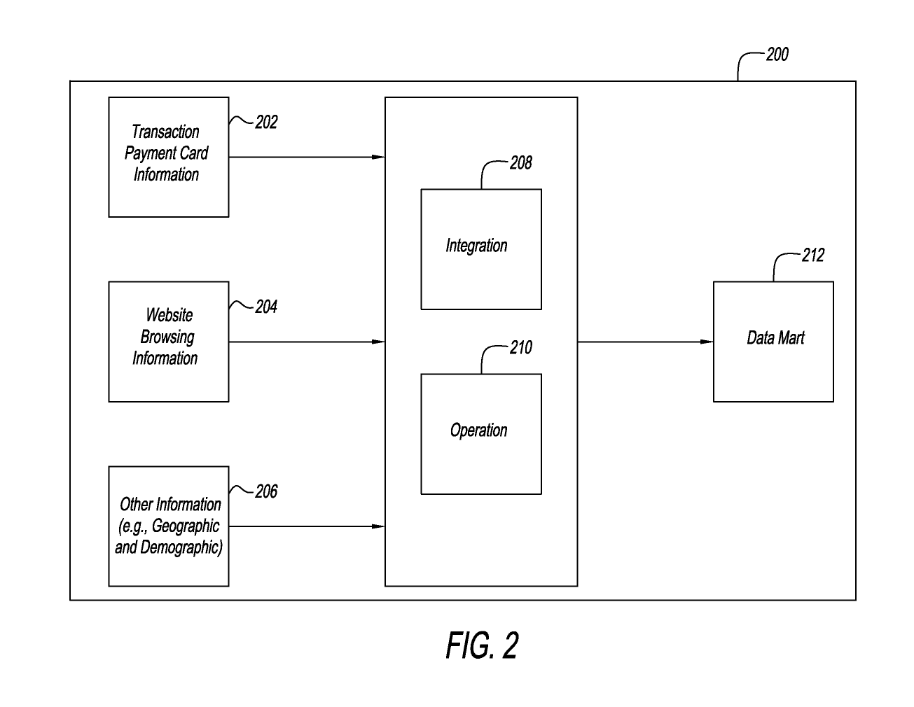

FIG. 2 illustrates an exemplary data warehouse 200 (the same data warehouse 200 in FIG. 1) for reporting and data analysis, including the storing, reviewing, and/or analyzing of information, for the various purposes described above. The data warehouse 200 can contain a plurality of entries (e.g., entries 202, 204, and 206).

The payment card transaction information 202 can contain, for example, purchasing and payment activities attributable to purchasers (e.g., payment card holders), that is aggregated by merchant and/or category and/or location in the data warehouse 200. The website browsing information 204 includes, for example, websites visited by the audience of potential acceptors, the date and time of websites visited by the audience of potential acceptors, and the like. Other information 206 can include demographic or geographic or other suitable information that can be useful in constructing one or more definitions of one or more definitions of payment card transaction date and time periods, one or more definitions of web browsing pattern, date and time periods, and one or more payment card holder lists by payment card transaction date and time period and by web browsing pattern, date and time period, to identify payment card holder overlap, and creating one or more groupings of payment card transaction date and time periods and web browsing pattern, date and time periods, based on the payment card holder overlap.

The typical data warehouse uses staging, data integration, and access layers to house its key functions. The staging layer or staging database stores raw data extracted from each of the disparate source data systems. The integration layer integrates at 208 the disparate data sets by transforming the data from the staging layer often storing this transformed data in an operational data store database 210. For example, the payment card transaction information 202 can be aggregated by merchant and/or category and/or location at 208, and correlated with web browsing information at 208. Also, the reporting and data analysis, including the storing, reviewing, and/or analyzing of information, for the various purposes described above, can occur in data warehouse 200. The integrated data is then moved to yet another database, often called the data warehouse database or data mart 212, where the data is arranged into hierarchical groups often called dimensions and into facts and aggregate facts. The access layer helps users retrieve data.

A data warehouse constructed from an integrated data source systems does not require staging databases or operational data store databases. The integrated data source systems can be considered to be a part of a distributed operational data store layer. Data federation methods or data virtualization methods can be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 212 is a small data warehouse focused on a specific area of interest. For example, the data mart 212 can be focused on one or more of reporting and data analysis, including the storing, reviewing, and/or analyzing of information, for any of the various purposes described above. Data warehouses can be subdivided into data marts for improved performance and ease of use within that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, online analytical processing, market research and decision support. However, the means to retrieve and analyze data, to extract, transform and load data, and to manage the data dictionary are also considered essential components of a data warehousing system. Many references to data warehousing use this broader context. Thus, an expanded definition for data warehousing includes business intelligence tools, tools to extract, transform and load data into the repository, and tools to manage and retrieve metadata.

Algorithms can be employed to determine formulaic descriptions of the integration of the data source information using any of a variety of known mathematical techniques. These formulas in turn can be used to derive or generate one or more analyses and updates for analyzing, creating, comparing and identifying activities using any of a variety of available trend analysis algorithms. For example, these formulas can be used in the reporting and data analysis, including the storing, reviewing, and/or analyzing of information, for the various purposes described above.

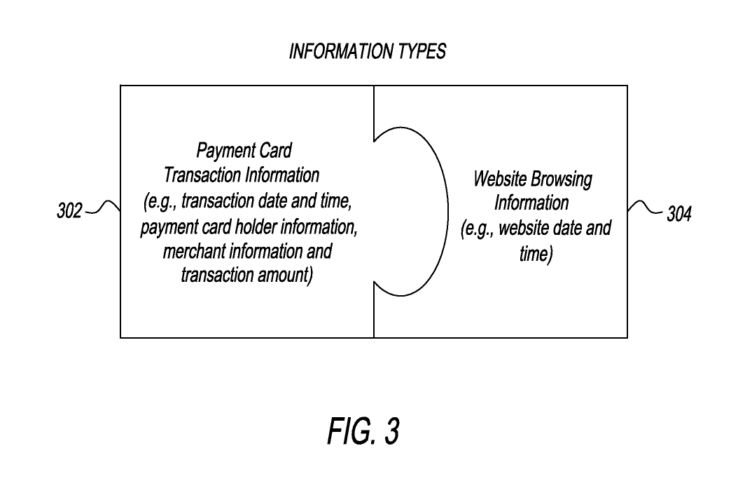

In accordance with the method of this disclosure, information that is stored in one or more databases can be retrieved (e.g., by a processor). FIG. 3 shows illustrative information types used in the systems and methods of this disclosure.

The information can contain, for example, a first set of information including payment card transaction information 302. Illustrative first set of information can include, for example, transaction date and time, payment card holder information, merchant information and transaction amount. In particular, the payment card transaction information can include, for example, transaction date/time, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like), and payment transaction amount information. Information for inclusion in the first set of information can be obtained, for example, from payment card companies known as MasterCard®, Visa®, American Express®, and the like (part of the payment card company network 150 in FIG. 1).

The information can also contain, for example, a second set of information including website browsing information. Illustrative second set information can include, for example, internet user data, such as an identifier of the user (e.g., cookie ID, IP address, and the like), that is collected during a website visit.

Website browsing information can include an internet user's browsing pattern at a website. The user activity can include, for example, selecting a hyperlink with an input device, typing a search string into a search interface, typing a URL into a browser, loading a page in a browser, and so forth. Data about the website pages involved in the user activities can be collected. The data about the pages can include page types, categories, topics, companies, an absolute or relative time of occurrence for the activity, the page type of a page viewed, a product associated with a page viewed, and so forth. In an embodiment, user activities and associated data from a data store, or a cookie, that includes past activities of a user at a website can be collected. The collected information about user activity can be from a URL, for example, when a URL contains a product ID, a category ID, or search terms.

User behavior can include interactions with a website, such as, but not limited to, web pages loaded by the user, search strings entered from the user, forms filled out, or purchases completed. The data about the pages at the website that a user has viewed can be examined. The page types, categories, and/or product types associated with the pages that a user has viewed at the website can be aggregated and/or analyzed. The information can be further collected and/or analyzed to determine the subject matter that a user is interested in, for example, a type of product, a service, a news item, a sports team, a hobby, and so forth.

The user browsing patterns can be analyzed to determine an area of interest. For example, user activity can be examined to determine what page types the user is viewing, categories of products, page content, or what products are being viewed. The number of times that a page type or a product is viewed can be counted. Analyzing user browsing patterns can include computing a weighted average of the number of times a page type was viewed in a time window, for example, with more recently viewed page types having more weight.

In an embodiment, the website browsing information can be obtained, for example, from a tracking service. The internet user's interaction with websites is tracked by a tracking service, which can track information such as websites viewed by the user, the number of times a user has viewed a particular website, whether a user has hovered over a website, and/or whether a user has made a purchase at a website. The tracking service can track information such as website pages viewed by the user, search queries submitted by the user, and search results selected by a user.

The tracking service can include one or more servers or other computing devices that may be employed to track online activity for user devices. The tracking service can be provided by a tracking service provider. In some embodiments, the tracking service provider and a payment card company can be a single entity, while in other embodiments they are separate entities.

The tracking service tracks user interactions with websites. The interaction can include, for instance, websites accessed by the user device, a number of times a particular website has been accessed by the user device, whether a user has hovered over a presented website (e.g., by using a pointing device to place a cursor over a product or advertisement included on the website), and/or whether a user has purchased a product at a website (e.g., by using pointing device to select and purchase the product). In further embodiments, the tracking service can also track online activity other than user interactions with the purchase of products. For instance, the tracking service can track information such as web pages viewed by a user during web browsing, search queries submitted to a search engine, and search results selected by a user.

Those skilled in the art will recognize that a variety of techniques can be employed for tracking online activities of user devices. For instance, the tracking server can employ cookies to track online activities for the user device. In some embodiments, a client application can reside on the user device to track activities and to communicate information regarding those activities to the tracking server. In general, any mechanisms now known or later developed for tracking online activities of the user device can be employed within the scope of embodiments of the present disclosure.

In one embodiment, a computing apparatus can correlate, or provide information to facilitate the correlation of, payment card transactions with online activities of the customers, such as searching, web browsing, social networking and consuming advertisements. The correlation results are used in predictive models to predict transactions and/or spending patterns based on website browsing patterns, to make timely and targeted advertisements.

Further, other information can contain, for example, external information (not shown in FIG. 3). Illustrative external information can include, for example, geographic and demographic information. In particular, the external information can include, for example, geographic areas (e.g., metropolitan areas (metropolitan statistical area (MSA), designated market area (DMA), and the like), event venues, and the like). The external information can be categorized, for example, by country, state, zip code, and the like. The geolocations can be clustered (i.e., location clusters) by category, for example, by activities, events, or other categories.

In an embodiment, all information stored in each of the one or more databases can be retrieved. In another embodiment, only a single entry in each database can be retrieved. The retrieval of information can be performed a single time, or can be performed multiple times. In an exemplary embodiment, only information pertaining to a specific predictive travel pattern profile is retrieved from each of the databases.

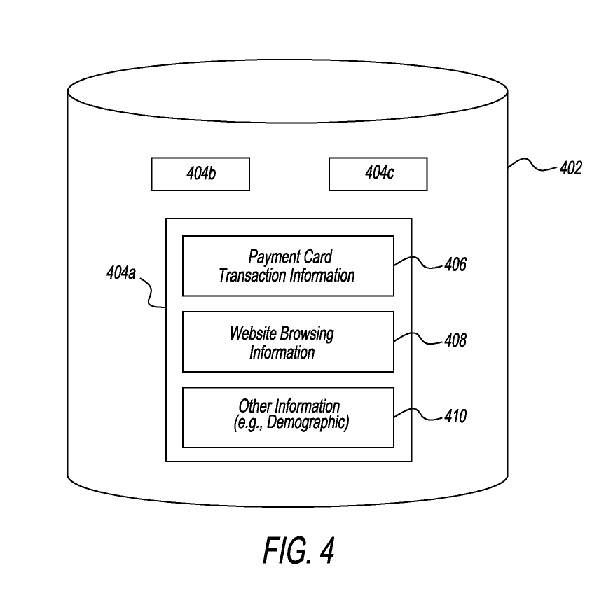

FIG. 4 illustrates an exemplary dataset 402 for the storing, reviewing, and/or analyzing of information used in the systems and methods of this disclosure. The dataset 402 can contain a plurality of entries (e.g., entries 404a, 404b, and 404c).

As described herein using, for example, entity 404a, entity 404a can include payment card holder transaction information 406, website browsing information 408, and other information 410. The payment card holder transaction information 406 includes payment card transactions and actual spending. The payment card transaction information 406 can contain, for example, transaction date/time, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like), payment transaction amount information, and the like.

The website browsing information 408 can include, for example, internet user data, such as an identifier of the user (e.g., cookie ID, IP address, etc.), that is collected during a website visit.

The other information 410 includes, for example, geographic, demographic or other suitable information that can be useful in conducting the systems and methods of this disclosure.

Algorithms can be employed to determine formulaic descriptions of the integration of the payment card transaction information and the website browsing information using any of a variety of known mathematical techniques. These formulas, in turn, can be used to derive or generate one or more analyses and updates for identifying associations between the payment card transaction information and the website browsing information using any of a variety of available trend analysis algorithms. For example, these formulas can be used to analyze the payment card transaction data, website browser information, and the external information to construct one or more definitions of payment card transactions and one or more payment card holder lists by payment card transactions to identify payment card holder overlap, and one or more definitions of payment card transactions, one or more definitions of web browsing pattern, date and time, and one or more payment card holder lists by payment card transaction date and time period and by web browsing pattern, date and time, to identify payment card holder overlap, and to create one or more groupings of payment card transaction date and time periods and web browsing pattern, date and time based on the payment card holder overlap, and one or more datasets to store information relating to the one or more groupings of payment card transaction date and time periods and web browsing pattern, date and time periods.

In an embodiment, logic is developed for creating one or more groupings payment card transaction date and time periods and web browsing pattern, date and time periods based on the payment card holder overlap. The logic is applied to a universe of payment card transaction date and time periods and web browsing pattern, date and time periods to create associations between the payment card transaction date and time periods and the web browsing pattern, date and time periods.

In accordance with the method of this disclosure, information that is stored in one or more databases can be retrieved (e.g., by a processor). The information can contain, for example, billing activities attributable to the financial transaction processing entity (e.g., a payment card company) and purchasing and payment activities, including date and time, attributable to the audience of potential acceptors (e.g., payment card holders), website browsing pattern activities, including date and time, demographic (e.g., age and gender), geographic (e.g., zip code and state or country of residence), and the like. At least a portion of the purchasing and payment activity information has a transaction, date and time identifier. At least a portion of the website browsing activity information has a date and time identifier for one or more websites visited by the audience of potential acceptors. Other illustrative information can include, for example, demographic (e.g., age and gender), geographic (e.g., zip code and state or country of residence), and the like.

In an embodiment, all information stored in each database can be retrieved. In another embodiment, only a single entry in each of the one or more databases can be retrieved. The retrieval of information can be performed a single time, or can be performed multiple times. In an exemplary embodiment, only information pertaining to a specific predictive behavioral model is retrieved from each of the databases.

In accordance with the method of this disclosure, one or more predictive behavioral models are generated based at least in part on the first set of information and the second set of information. Predictive behavioral models can be selected based on the information obtained and stored in the one or more databases. The selection of information for representation in the predictive behavioral models can be different in every instance. In one embodiment, all information stored in each database can be used for selecting predictive behavioral models. In an alternative embodiment, only a portion of the information is used. The generation and selection of predictive behavioral models can be based on specific criteria.

Predictive behavioral models are generated from the information obtained from each database. The information is analyzed, extracted and correlated by, for example, a financial transaction processing company (e.g., a payment card company), and can include financial account information, website browsing information, performing statistical analysis on financial account information and website browsing information, finding correlations between account information, website browsing information and consumer behaviors, predicting future consumer behaviors based on account information and website browsing information, relating information on a financial account and a website with other financial accounts and websites, or any other method of review suitable for the particular application of the data, which will be apparent to persons having skill in the relevant art.

Activities and characteristics attributable to the audience of potential acceptors, including time and date patterns associated with the activities and characteristics, based on the one or more predictive behavioral models are identified. The audience of potential acceptors has a propensity to carry out certain activities and to exhibit certain characteristics, at certain times and dates, based on the one or more predictive behavioral models. The activities and characteristics attributable to the audience of potential acceptors and based on the one or more predictive behavioral models are conveyed by the financial transaction processing entity to the entity making the timely and targeted offer. This conveyance enables a targeted offer to be timely made by the entity to the audience of potential acceptors. The transmittal can be performed by any suitable method as will be apparent to persons having skill in the relevant art.

Predictive behavioral models can be defined based on geographical or demographical information, including but not limited to, age, gender, income, marital status, postal code, income, spending propensity, and familial status. In some embodiments, predictive behavioral models can be defined by a plurality of geographical and/or demographical categories. For example, a predictive behavioral model can be defined for any card holder who engages in website browsing activity.

Predictive behavioral models can also be based on behavioral variables. For example, the financial transaction processing entity database can store information relating to financial transactions. The information can be used to determine an individual's likeliness to spend at a particular date and time. An individual's likeliness to spend can be represented generally, or with respect to a particular industry (e.g., electronics), retailer (e.g., Macy's®), brand (e.g., Apple®), or any other criteria that can be suitable as will be apparent to persons having skill in the relevant art. An individual's behavior can also be based on additional factors, including but not limited to, time, location, and season. For example, a predictive behavioral model can be based on consumers who are likely to spend on electronics during the holiday season, or on sporting goods throughout the year. The factors and behaviors identified can vary widely and can be based on the application of the information.

Behavioral variables can also be applied to generated predictive behavioral models based on the attributes of the entities. For example, a predictive behavioral model of specific geographical and demographical attributes can be analyzed for spending behaviors. Results of the analysis can be assigned to the predictive behavioral models. For example, the predictive behavioral model can reveal that the entities in the predictive behavioral model living and working in Fairfield County, Connecticut have a high spending propensity for electronics or sporting goods during weekdays from 6:00 pm to 10:00 pm and are less likely to spend from 8:00 am to 5:00 pm during weekdays, although website browsing activity occurs during both periods.

In an embodiment, the information retrieved from each of the databases can be analyzed to determine behavioral information of the audience of potential acceptors. Also, information related to an intention of the audience of potential acceptors can be extracted from the behavioral information. The predictive behavioral models can be based upon the behavioral information of the audience of potential acceptors and the intent of the audience of potential acceptors. The predictive behavioral models can be capable of predicting behavior and intent in the audience of potential acceptors.

Predictive behavioral models can be developed, for example, to examine spend behaviors and create spend associations. A spend association can be a set of spend behaviors that predict another spend behavior. For example, people that tend to purchase jewelry display the following spend behaviors: spend at Macy's®, travel on cruise ships, go to the movie theaters once a month, and so forth.

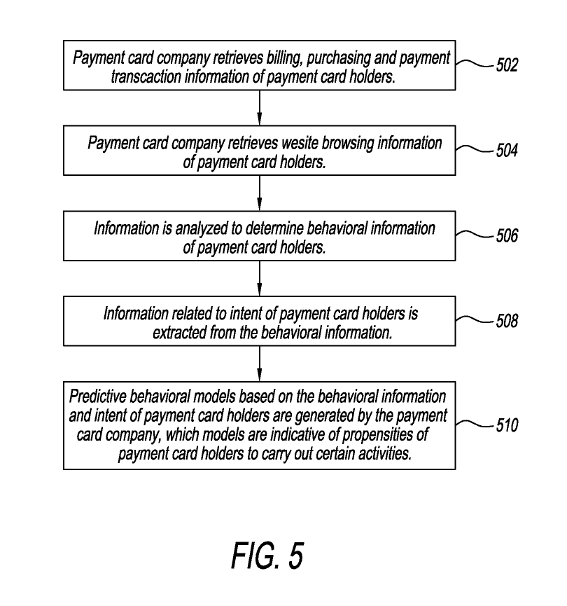

A method for generating one or more predictive behavioral models is an embodiment of this disclosure. Referring to FIG. 5, the method involves a payment card company (part of the payment card company network 150 in FIG. 1) retrieving, from one or more databases, information including activities and characteristics attributable to one or more payment card holders. The information 502 includes payment card billing, purchasing and payment transactions, and optionally demographic and/or geographic information. At least a portion of the purchasing and payment activity information has a transaction, date and time identifier. The payment card company also retrieves, from one or more databases, information including website browsing information 504 attributable to one or more payment card holders. The information 504 includes the date and time of websites visited by the one or more payment card holders, and optionally demographic and/or geographic information. At least a portion of the website browsing information has a website, date and time identifier for one or more websites visited by the one or more payment card holders. The information is analyzed at 506 to determine behavioral information of the one or more payment card holders. Information related to an intent of the one or more payment card holders is extracted from the behavioral information at 508. One or more predictive behavioral models are generated based on the behavioral information and intent of the one or more payment card holders at 510. The one or more payment card holders have a propensity to carry out certain activities at certain times based on the one or more predictive behavioral models.

In analyzing information to determine behavioral information, intent (audience) and other payment card member attributes are considered. Developing intent of audiences involves models that predict specific spend behavior at certain times in the future and desirable spend behaviors at certain dates and times. Examples include as follows: likely to purchase at Macy's® in the next 2 weeks during weekdays from 6:00 pm to 10:00 pm and less likely to purchase from 8:00 am to 5:00 pm during weekdays; likely to purchase a car in the next 60 days from 8:00 am to 5:00 pm during a weekend; and the like.

Predictive behavioral models can equate to purchase behaviors. There can be different degrees of predictive behavioral models with the ultimate behavior being a purchase. An example using Macy's® is as follows: an extreme behavior is a consumer purchasing something once a week at Macy's® during weekdays from 8:00 am to 10:00 pm and spending five times what the average customer spends; a medium behavior is a consumer purchasing something at Macy's® once a month during weekdays from 6:00 pm to 10:00 pm and spending twice what the average customer spends; and a low behavior is a consumer purchasing something at Macy's® once a year from 8:00 am to 5:00 pm during a weekend and spending what the average customer spends.

There is the potential for numerous predictive behavioral models including, for example, industries (e.g., consumer electronics, QSR), categories (e.g., online spend, cross border), geography spend (e.g., spend in New York City, spend in London), geography residence (e.g., live in New York City, live in Seattle), day/time spend (e.g., weekday spend, lunch time spend), calendar spend (e.g., spend a lot around Christmas, spend a lot on flowers before Valentine's Day), top number of merchants, and the like.

Other card holder attributes part of the information include, for example, geography (e.g., zip code, state or country), and demographics (e.g., age, gender, and the like).

The method further includes conveying to an entity the activities and characteristics attributable to the one or more payment card holders based on the one or more predictive behavioral models, to enable the entity to make a timely and targeted offer to the one or more payment card holders. The one or more predictive behavioral models are capable of predicting behavior and intent in the one or more payment card holders. The one or more payment card holders are people and/or businesses. The activities attributable to the one or more payment card holders are financial transactions associated with the one or more payment card holders, including time and date patterns associated with the financial transactions, and website browsing activities, including date and time patterns associated with the website browsing. The characteristics attributable to the one or more payment card holders are demographics and/or geographical characteristics of the one or more payment card holders.

A behavioral propensity score is used for conveying to the entity the activities and characteristics attributable to the one or more payment card holders based on the one or more predictive behavioral models. The behavioral propensity score is indicative of a propensity to exhibit a certain behavior.

Potential acceptor audiences can represent a wide variety of categories and attributes. In one embodiment, potential acceptor audiences can be created based on spending propensity of spending index in a particular industry. Industries can include, as will be apparent to persons having skill in the relevant art, restaurants (e.g., fine dining, family restaurants, fast food), apparel (e.g., women's apparel, men's apparel, family apparel), entertainment (e.g., movies, professional sports, concerts, amusement parks), accommodations (e.g., luxury hotels, motels, casinos), retail (e.g., department stores, discount stores, hardware stores, sporting goods stores), automotive (e.g., new car sales, used car sales, automotive stores, repair shops), travel (e.g., domestic, international, cruises), and the like. Each industry can include a plurality of potential acceptor audiences (e.g., based on location, income groups, and the like).

Potential acceptor audiences can also be based on predictions of future behavior. For instance, a financial transaction processing company can analyze financial account information and behavioral information to predict future behavior of a potential acceptor.

Potential acceptor audiences can also be aligned with other similar potential acceptor audiences. Similar potential acceptor audiences can be determined by similarities in, for example, the audience parameters (e.g., nearby postal codes), or in the entities contained in the predictive behavioral models (e.g., a larger number of card holders common to both audiences). In one embodiment, the financial transaction processing company can create potential acceptor audiences based on received parameters, which can be aligned to audiences created by a third party on the same parameters yet include different entities or behaviors. The process and parameters for the alignment of potential acceptor audiences can be dependent on the application of the audiences, as will be apparent to persons having skill in the relevant art.

A financial transaction processing company can analyze the generated predictive behavioral models (e.g., by analyzing the stored data for each entity comprising the predictive behavioral model) for behavioral information (e.g., spend behaviors and propensities). In some embodiments, the behavioral information can be represented by a behavioral propensity score. Behavioral information can be assigned to each corresponding predictive behavioral model, or can be assigned to an audience of predictive behavioral models.

Predictive behavioral models or behavioral information can be updated or refreshed at a specified time (e.g., on a regular basis or upon request of a party). Updating predictive behavioral models can include updating the entities included in each predictive behavioral model with updated demographic data and/or updated financial data and/or updated website browsing data. Predictive behavioral models can also be updated by changing the attributes that define each predictive behavioral model, and generating a different set of behaviors. The process for updating behavioral information can depend on the circumstances regarding the need for the information itself.

Although the above methods and processes are disclosed primarily with reference to financial data, website browsing data and spending behaviors, it will be apparent to persons having skill in the relevant art that the predictive behavioral models can be beneficial in a variety of other applications. Predictive behavioral models can be useful in the evaluation of consumer data that may need to be protected.

For instance, predictive behavioral models can have useful applications in measuring the effectiveness of advertising or other consumer campaigns. A party can desire to discover the effectiveness of a particular advertising campaign in reaching a specific set of consumers.

For example, a consumer electronics store may want to know the effectiveness of an advertising campaign initiated by the store and directed towards male consumers of a specific age and income group. The store can provide the financial transaction processing company with the demographic (e.g., demographical and geographical) data corresponding to the market. The financial transaction processing company can obtain financial transaction data and website browsing data. The financial transaction processing company can identify predictive behavioral models with corresponding financial transaction data, website browsing data and demographic data, and summarize relevant spend behaviors for the identified predictive behavioral models. Summary of the relevant spend behaviors (e.g., showing an increase or decrease in spending at the consumer electronic store at particular times and dates) for each predictive behavioral model (e.g., including the predictive behavioral models of ideal consumers) can be provided to the consumer electronics store.

Predictive behavioral model data can also be combined or matched with other sources of data. For example, other transaction processing agencies, advertising firms, advertising networks, publishers, etc. can provide information on consumer groupings of their own. The financial transaction processing company can link or match the received consumer groupings, such as by matching groupings to generated predictive behavioral models based on geographical or demographical data.

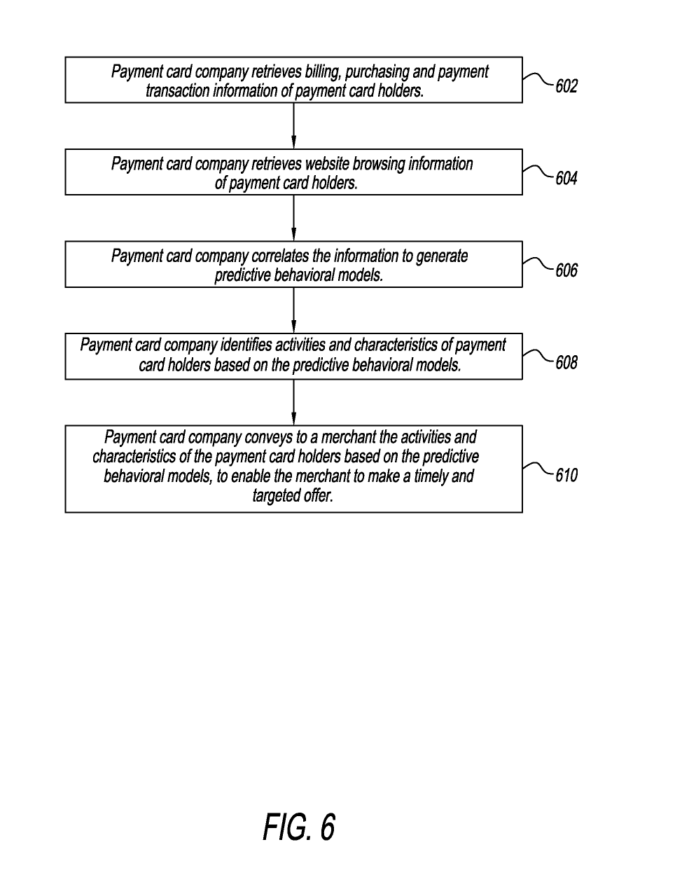

FIG. 6 illustrates an exemplary method for making a timely and targeted offer by an entity to an audience of potential acceptors. In step 602, a payment card company (part of the payment card company network 150 in FIG. 1) retrieves, from one or more databases, information including activities and characteristics attributable to one or more payment card holders. The information at 602 includes payment card billing, purchasing and payment transactions, and optionally demographic and/or geographic information. At least a portion of the purchasing and payment activity information has a transaction, date and time identifier. At 604, the payment card company also retrieves, from one or more databases, information including website browsing information attributable to one or more payment card holders. The information at 604 includes the date and time of websites visited by the one or more payment card holders, and optionally demographic and/or geographic information. At least a portion of the website browsing information has a website, date and time identifier for one or more websites visited by the one or more payment card holders.

The payment card company analyzes the first set of information and second set of information to determine behavioral information of the audience of potential acceptors. The payment card company extracts information related to intent of the audience of potential acceptors from the behavioral information.

At step 606, based on at least one of selected activities criteria and selected characteristics criteria from the first set of information and second set of information, including behavioral information and intent of the audience of potential acceptors, a plurality of predictive behavioral models are generated. The payment card company generates predictive behavioral models based on the purchasing and payment activity information and website browsing information at 606, and identifies activities and characteristics attributable to potential purchasers based on the predictive behavioral models at 608. Activities and to the audience of potential acceptors based on the one or more predictive behavioral models are identified at 608. The audience of potential acceptors has a propensity to carry out certain activities and to exhibit certain characteristics based on the one or more predictive behavioral models.

The activities and characteristics attributable to the audience of potential acceptors based on the one or more predictive behavioral models are conveyed to an entity, such as a merchant at 610, to enable the entity to make a timely and targeted offer to the audience of potential acceptors. In an embodiment, the payment card company conveys to the entity at 610 a behavioral propensity score based on the predictive behavioral models. The score is indicative of a propensity of a potential purchaser to exhibit a certain behavior.

One example of a predictive behavioral model is as follows: live in the following zip codes AND engage in website browsing between 6:00 pm and 10:00 pm during weekdays AND purchase consumer electronics during website browsing time, and the like. Another example of a predictive behavioral model is as follows: between the ages of 25-35 AND engage in website browsing between 8:00 am and 10:00 pm during weekends AND purchase sporting goods during website browsing time, and the like.

In step 610, the predictive behavioral models are used to predict behavior and intent in an audience of potential acceptors (e.g., the above predictive behavioral model examples are used to predict individuals likely to purchase consumer electronics or sporting goods in the next week). The entity executes promotions to targeted potential purchasers through a mobile channel or e-mail.

In an embodiment, the entity provides feedback to the payment card company to enable the payment card company to monitor and track impact of targeted offers. This “closed loop” system allows an entity to track advertising campaigns, measure efficiency of the targeting, and make any improvements for the next round of campaigns.

One or more algorithms can be employed to determine formulaic descriptions of the assembly of the payment card holder information including payment card billing, purchasing and payment transactions, website browsing information, and optionally demographic and/or geographic information, using any of a variety of known mathematical techniques. These formulas in turn can be used to derive or generate one or more predictive behavioral models using any of a variety of available trend analysis algorithms.

Where methods described above indicate certain events occurring in certain orders, the ordering of certain events can be modified. Moreover, while a process depicted as a flowchart, block diagram, or the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.”

It should be understood that the present disclosure includes various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method for making a timely and targeted offer by an entity to an audience of potential acceptors, said method comprising:
retrieving, from one or more databases, a first set of information including purchasing and payment activity information attributable to said audience of potential acceptors, wherein at least a portion of the purchasing and payment activity information has a transaction, date and time identifier;
retrieving, from one or more databases, a second set of information including website browsing information attributable to the audience of potential acceptors, wherein at least a portion of the website browsing information has a website, date and time identifier for one or more websites visited by the audience of potential acceptors;
correlating the first set of information with the second set of information to generate one or more predictive behavioral models;
identifying activities and characteristics, including time and date patterns associated with said activities and characteristics, attributable to the audience of potential acceptors based on the one or more predictive behavioral models; and
conveying to the entity said activities and characteristics, including said time and date patterns associated with said activities and characteristics, attributable to the audience of potential acceptors based on the one or more predictive behavioral models, to enable the entity to make a timely and targeted offer to the audience of potential acceptors.

2. The method of claim 1, wherein said correlating comprises:
analyzing the first set of information and the second set of information to determine behavioral information of the audience of potential acceptors; and
extracting information related to an intent of the audience of potential acceptors from the behavioral information.

3. The method of claim 2, wherein the one or more predictive behavioral models are based upon the behavioral information of the audience of potential acceptors and the intent of the audience of potential acceptors.

4. The method of claim 1, wherein the audience of potential acceptors are people and/or businesses, wherein the activities attributable to the audience of potential acceptors are financial transactions, including time and date patterns associated with said financial transactions, and website browsing, including time and date patterns associated with said website browsing, and wherein the characteristics attributable to the audience of potential acceptors are demographics and/or geographical characteristics.

5. The method of claim 1, wherein the first set of information comprises the date and time of payment card billing, purchasing and payment transactions by the audience of potential acceptors, and optionally demographic and/or geographic information.

6. The method of claim 1, wherein the second set of information comprises websites visited by the audience of potential acceptors, the date and time of websites visited by the audience of potential acceptors, and optionally demographic and/or geographic information.

7. The method of claim 1, wherein the audience of potential acceptors comprise payment card holders.

8. The method of claim 1, wherein the entity makes a timely and targeted offer to the audience of potential acceptors by e-mails, text messages, phone calls or television.

9. The method of claim 1, further comprising:
tracking and measuring impact of the timely and targeted offer based at least in part on purchasing and payment activities attributable to the audience of potential acceptors, after the timely and targeted offer has been made.

10. The method of claim 1, wherein the one or more predictive behavioral models provides a behavioral propensity score that is used for conveying to the entity said activities and characteristics, and said time and date pattern associated with said activities and characteristics, attributable to the audience of potential acceptors based on the one or more predictive behavioral models, and wherein the behavioral propensity score is indicative of a propensity to exhibit a certain behavior.

11. The method of claim 1, wherein the entity comprises one or more merchant entities.

12. A system for making a timely and targeted offer by an entity to an audience of potential acceptors, said system comprising:
one or more databases configured to store a first set of information including purchasing and payment activity information attributable to the audience of potential acceptors, wherein at least a portion of the purchasing and payment activity information has a transaction, date and time identifier;
one or more databases configured to store a second set of information including website browsing information attributable to the audience of potential acceptors, wherein at least a portion of the website browsing information has a website, date and time identifier for one or more websites visited by the audience of potential acceptors;
a processor configured to:
correlate the first set of information with the second set of information to generate one or more predictive behavioral models; and
identify activities and characteristics, including time and date patterns associated with said activities and characteristics, attributable to the audience of potential acceptors based on the one or more predictive behavioral models; and
a device for conveying to the entity said activities and characteristics, including said time and date patterns associated with said activities and characteristics, attributable to the audience of potential acceptors based on the one or more predictive behavioral models, to enable the entity to make a timely and targeted offer to the audience of potential acceptors.

13. The system of claim 12, wherein the processor is configured to:
analyze the first set of information and the second set of information to determine behavioral information of the audience of potential acceptors; and
extract information related to an intent of the audience of potential acceptors from the behavioral information.

14. The system of claim 13, wherein the one or more predictive behavioral models are based upon the behavioral information of the audience of potential acceptors and the intent of the audience of potential acceptors.

15. The system of claim 12, wherein the first set of information comprises the date and time of payment card billing, purchasing and payment transactions by the audience of potential acceptors, and optionally demographic and/or geographic information.

16. The system of claim 12, wherein the second set of information comprises websites visited by the audience of potential acceptors, the date and time of websites visited by said audience of potential acceptors, and optionally demographic and/or geographic information.

17. The system of claim 12, wherein the audience of potential acceptors comprise payment card holders.

18. The system of claim 12, wherein the processor is configured to:
track and measure impact of the timely and targeted offer based at least in part on purchasing and payment activities attributable to the audience of potential acceptors, after the timely and targeted offer has been made.

19. The system of claim 12, wherein the one or more predictive behavioral models provides a behavioral propensity score that is used for conveying to the entity said activities and characteristics, and said time and date pattern associated with said activities and characteristics, attributable to the audience of potential acceptors based on the one or more predictive behavioral models, and wherein the behavioral propensity score is indicative of a propensity to exhibit a certain behavior.

20. A method for generating one or more predictive behavioral models, said method comprising:
retrieving, from one or more databases, a first set of information including purchasing and payment activity information attributable to an audience of potential acceptors, wherein at least a portion of the purchasing and payment activity information has a transaction, date and time identifier;
retrieving, from one or more databases, a second set of information including website browsing information attributable to the audience of potential acceptors, wherein at least a portion of the website browsing information has a website, date and time identifier for one or more websites visited by the audience of potential acceptors;
analyzing the first set of information and the second set of information to determine behavioral information of the audience of potential acceptors;
extracting information related to an intent of the audience of potential acceptors from the behavioral information; and
generating one or more predictive behavioral models based on the behavioral information and intent of the audience of potential acceptors with the audience of potential acceptors having a propensity to carry out certain activities based on the one or more predictive behavioral models.

21. The method of claim 20, further comprising:
conveying to an entity activities and characteristics, including time and date patterns associated with said activities and characteristics, attributable to the audience of potential acceptors based on the one or more predictive behavioral models, to enable the entity to make a timely and targeted offer to the audience of potential acceptors.

22. The method of claim 21, wherein the one or more predictive behavioral models are capable of predicting behavior and intent in the audience of potential acceptors.
